(19) United States
(12) Patent Application Publication
(10) Pub. No.: US 2012/0205458 A1
(43) Pub. Date: Aug. 16, 2012

(54) NOZZLE FOR NEEDLE-FREE INJECTORS

(76) Inventors: Nicky CANTON, Shenzhen (CN); Bart HEGEMAN, Alkmaar (NL)

(21) Appl. No.: 13/024,333

(22) Filed: Feb. 10, 2011

(51) Int. Cl. B05B 17/00; B05B 1/02

(52) U.S. Cl. 239/1; 239/589

(57) ABSTRACT

A nozzle is disclosed which includes a container member and a nozzle head. The container member has an internal space and a first end with an attachment mechanism adapted to attach to a needle free injector. The nozzle head has a first end and a second end in which the first end has an attachment part adapted to attach to the attachment mechanism of the container member. The second end of the nozzle head has a wall with at least one injection orifice. The container member and the nozzle head are separate parts but connectable to each other. A method of loading an injectable into a nozzle for needle-free injector is also disclosed.

### FIELD OF INVENTION

This invention relates to a nozzle for needle-free injectors, and in particular one with a modular setup.

### BACKGROUND OF INVENTION

Conventional nozzles are often limited in their usage as the specific geometry of the nozzle makes it only suitable for a typical range of injectables and application systems. Different injectables may require different dosing volume ranges, and the limit in dosing volume that can be comfortably injected through one orifice results in the requirement of multiple orifices. Different injectables may also require different application systems which provide the desired power output suitable for that specific nozzle-injectable combination.

Additionally conventional nozzles are often not ergonomically shaped which may lead to discomfort during injection.

### SUMMARY OF INVENTION

In the light of the foregoing background, it is an object of the present invention to provide an alternate nozzle for injectors, especially for needle-free injectors.

Accordingly, the present invention, in one aspect, is a nozzle comprising a container member and a nozzle head. The container member comprises an internal space and a first end with an attachment mechanism adapted to attach to a needle free injector. The nozzle head comprises a first end and a second end in which the first end comprises an attachment part adapted to attach to the attachment mechanism of the container member. The second end of the nozzle head comprises a wall with at least one injection orifice. The container member and the nozzle head are separate parts but connectable to each other.

In an exemplary embodiment, the container member is adapted to contain an injectable within the internal space thereof. The attachment mechanism comprises an injector connector being hollow axially and adapted to attach to the first end of the container member. The injector connector and container member are separate parts but connectable to each other. In yet another exemplary embodiment, the injector connector comprises a flange on each of the front end and rear end with a recess disposed between the two flanges.

In another exemplary embodiment of this invention, the nozzle head comprises a front surface with an enlarged area relative to the container member and protrudes convexly for interaction with the concave profile of sunken skin of a subject such that when pressure is applied during injection, the area of contact between the injector and the skin of the subject is increased. The geometry of the nozzle head is designed as such to reduce discomfort during injection by increasing the area of contact between the injector and the skin, and the pressure exerted on the skin is also reduced.

In an exemplary embodiment of the present invention, the nozzle further comprises a piston adapted to fittingly insert into the internal space of the container member and a nozzle ram attached to a front end of the piston. As such, a fluid cavity is defined with the nozzle head acting as a front wall, the container member acting as a side wall, and the nozzle ram acting as a rear wall of the fluid chamber.

In another exemplary embodiment, the shape of at least one of the flanges of the injector connector and the length of the container member are specific to the type of injectable contained within the container member. The rear end of the rear flange is frusto-conical in shape.

According to another aspect of the present invention, a nozzle is provided comprising a container member and a nozzle head in which the nozzle head comprises a front surface having at least one injection orifice through which injectable may be dispensed under pressure. The front surface protrudes convexly for interaction with the concave profile of sunken skin of a subject such that when pressure is applied during injection, the area of contact between the injector and the skin of the subject is increased. In one exemplary embodiment, the front surface of the nozzle head comprises an enlarged area relative to the container member.

In another exemplary embodiment, the nozzle head comprises a wall and that the wall and the injection orifice are organized in a concentric fashion.

In one exemplary embodiment, the number of injection orifice is specific to the type of and/or dosage of the injectable to a subject in need thereof.

In a further aspect of the present invention, a method of loading an injectable into a nozzle for a needle-free injector is provided comprising the steps of a) providing a space inside the nozzle; b) filling the space with the injectable under ambient pressure within the space; and c) closing the space to prevent leakage of the injectable under ambient pressure.

In one exemplary embodiment, step (a) of the loading method further comprises providing a container member of the nozzle comprising a front end, a rear end in which the space is disposed between the front and rear ends; and closing the rear end of the space by inserting fittingly a piston into the space at the rear end of the container member such that a nozzle ram disposed at a front end of the piston is located at a predetermined position relative to the container member. In yet another exemplary embodiment, the piston is stationary and remains at the predetermined position during the loading of the injectable into the space.

In a further exemplary embodiment, step (b) of the method further comprises loading an injectable into the space at a front end thereof; and attaching a nozzle head onto the front end, thereby enclosing the injectable in the nozzle.

There are many advantages to the present invention. For example, the nozzle can be made to dedicate for a specific type of injectable through customizing the nozzle head, the fluid container and/or the injector connector separately. The instant invention also provides a platform in which sets of modular nozzle parts are used which can be combined into unique combinations that fit the requirements of different injectables. This platform offers flexibility in terms of the dosing chamber volume, number of orifices, connection to the application systems and the filling method. In addition, it can easily be customized in production to fit for a wide range of application systems.

Also, the nozzle head has a front surface with an enlarged area relative to the container member. As such, the average pressure and thus the pain exerted on the user by the nozzle, and thus by the needle free injector, would then be greatly reduced due to the increased contact area defined by the enlarged front surface, which would be in contact with the sunken skin of the user. Thus the ergonomically designed nozzle head helps to make injection more comfortable to the user.

Another advantage of the present invention is that since the nozzle is separately provided from the needle-free injector, the nozzle can potentially be pre-loaded with an injectable at the manufacturing process. Therefore, in preparation of the injection, a user only needs to attach the nozzle to the injector without the time-consuming step of loading the correct amount of injectable into the nozzle, as such the overall injection process can be potentially performed in a much faster pace than that for the conventional injectors without compromising the safety or quality of the injection.

### BRIEF DESCRIPTION OF FIGURES

FIG. 1 is an exploded diagram in a perspective view of the nozzle according to one embodiment of the present invention.

FIG. 2 is a perspective view of the piston of the nozzle.

FIG. 3a is a top view of the nozzle head having one injection base with one injection orifice disposed thereon according to one embodiment of the present invention.

FIG. 3b is a top view of the nozzle head having three injection bases with three injection orifices disposed thereon according to another embodiment of the present invention.

FIG. 3c is a side view of the nozzle head having one injection base according to one embodiment of the present invention.

FIG. 4 is a perspective view of an assembled nozzle.

FIGS. 5a-5c display a cross-sectional view of the assembled nozzle to illustrate the filling of an injectable into the nozzle.

### DETAILED DESCRIPTION OF THE PREFERRED EMBODIMENTS

As used herein and in the claims, “comprising” means including the following elements but not excluding others.

The term “connectable” means that separate parts that are connected during manufacturing/assembly process, but may or may not be disconnectable without losing the function of each part upon assembly.

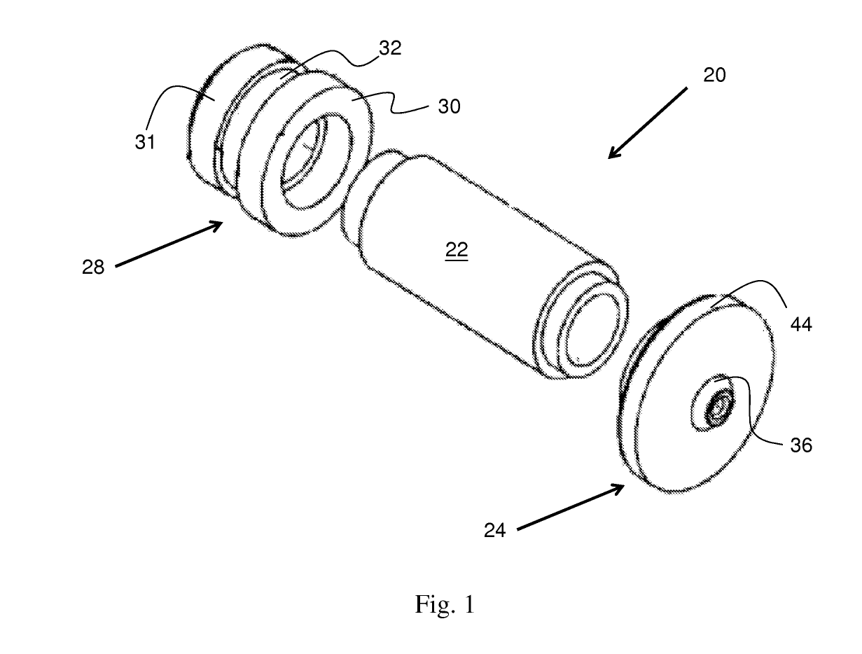

Referring now to FIG. 1, the first embodiment of the present invention is a nozzle 20 comprising an axially hollow container member 22 with open front and rear ends, a nozzle head 24, and an axially hollow injector connector 28. The nozzle head 24 comprises an injection disc 44 on which an injection base 36 is disposed. Further, the injection disc 44 comprises a front surface with an enlarged area relative to the container member 22. The nozzle head further comprises a fluid container connector 34 at its rear end adapted to attach to the front end of the container member 22.

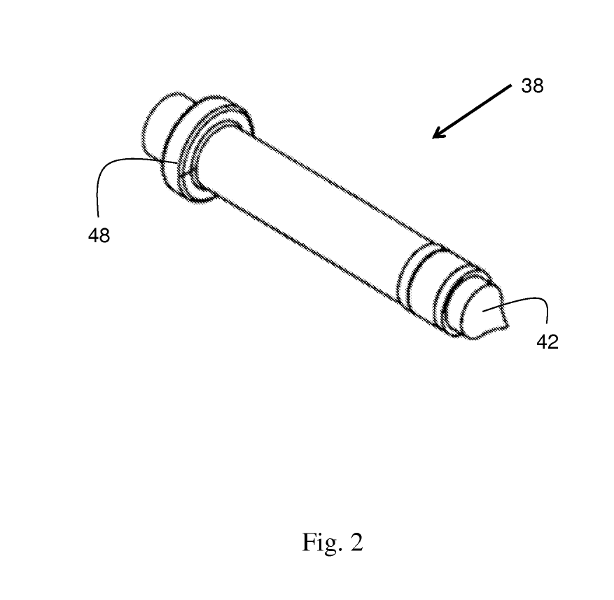

In the embodiment as shown, the injector connector 28 is an axially hollow ring comprising an annular flange on each of its front and rear ends, with a recess 32 disposed therebetween. The injector connector 28 is attached to the peripheral edge of the container member 22 from its rear end. In this embodiment, the injector connector 28 serves an attachment mechanism of the container member 22 adapted to attach to an external needle free injector. At an attached position, the front flange 30 abuts the container member 22, while the rear edges of the container member 22 and the front edges of the injector connector 28 are aligned. The rear end of the injector connector 28 is provided in a frusto-conical shape to facilitate attachment to the external needle-free injector. The piston 38, as shown in FIG. 2 and comprising a nozzle ram 42 at its front end and an annular piston flange 48 at its rear end, is adapted to fittingly insert into the hollow of the container member 22.

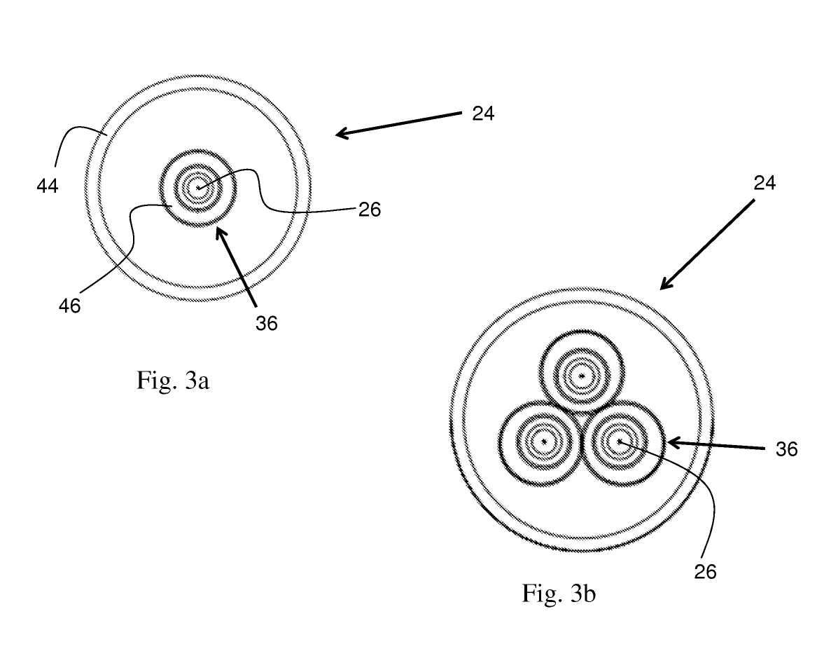

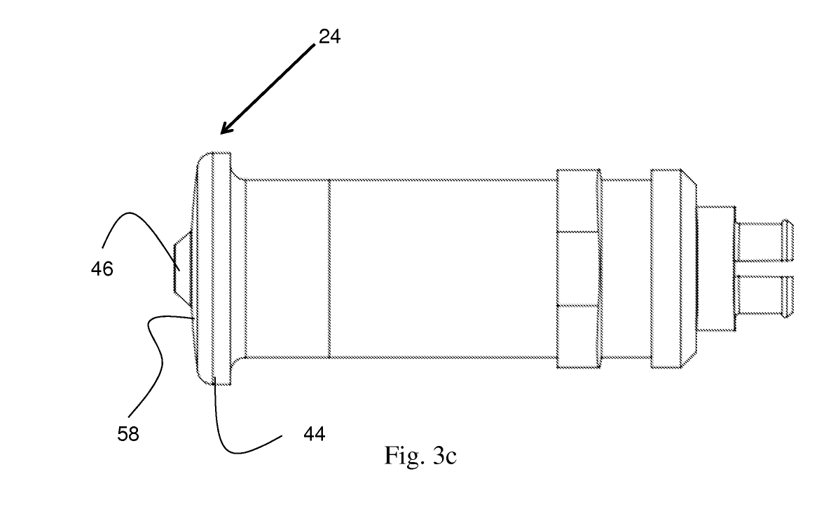

The front surface of the injection disc 44 of the nozzle head 24 according to an embodiment of the present invention is shown in FIG. 3a. An injection base 36, disposed at a center of the injection disc 44, comprises a wall 46 and an injection orifice 26 disposed within the wall 46, such that the wall 46 and the injection orifice 26 are organized in a concentric fashion. The orifice 26 is adapted for releasing the injectable upon urging the nozzle ram 42 towards the nozzle head 24. In another embodiment, the nozzle head 24 comprises more than one injection orifice 26 in which the number of injection orifices 26 is specific to the type of and/or the dosage of the injectable to be injected into a subject in need thereof. For instance, FIG. 3b shows an embodiment in which each of the three injection orifices 26 is disposed on an injection base 36 of the nozzle head 24. In an exemplary embodiment, the injection orifices 26 and the walls 46 are organized in a circularly symmetric fashion.

In an exemplary embodiment as shown in FIG. 3c, the front surface 58 of the injection disc 44 is convex in shape, with the peripheral edge of the surface being rounded, in order to ergonomically interact with the subject being injected. As such, the convex front surface 58 will interact and comply with the concave profile of the sunken skin profile of the subject during injection, so when pressure is applied during injection, the area of contact between the injector and the skin of the subject is increased. Consequently, together with the enlarged surface area, the average pressure exerted on the subject during injection will be reduced, minimizing discomfort for the subject. In addition, the convex front surface 58 is more effective in spreading the pressure throughout comparing to a completely flat surface, as the subject's skin profile will change more smoothly in accordance with a convex surface than a flat surface upon being pressed with the nozzle. However, if the surface is too convex then the nozzle is prone to sliding during injection. Lastly, the peripheral edge of the front surface 58 is made to be more convex or rounded than the center portion of the front surface 58, further reducing the pressure along the edge and prevents leaving an injection mark on the subject during injection. Even though the front surface 58 is convex in shape, the front edge of the wall 46 is still made planar to prevent sliding of the nozzle head 24 on the patient's skin during injection.

Now turning to the operation of the nozzle described above, FIG. 4 shows an assembled nozzle 20 according to an embodiment of the present invention. In this embodiment, the nozzle head 24 is attached to the front end of the container member 22, while the rear end of the container member 22 is attached with the injector connector 28. The recess 32 of the injector connector 28 is adapted to attach to a corresponding protrusion of an external needle-free injector in one embodiment.

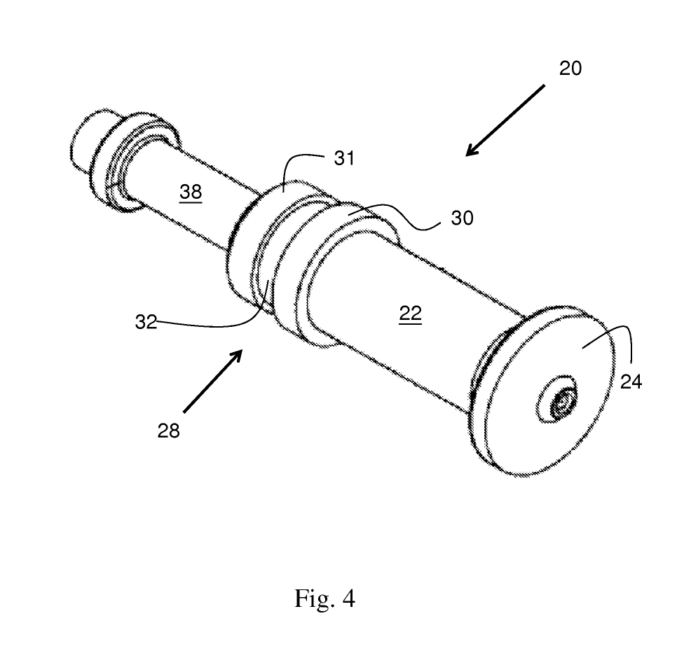

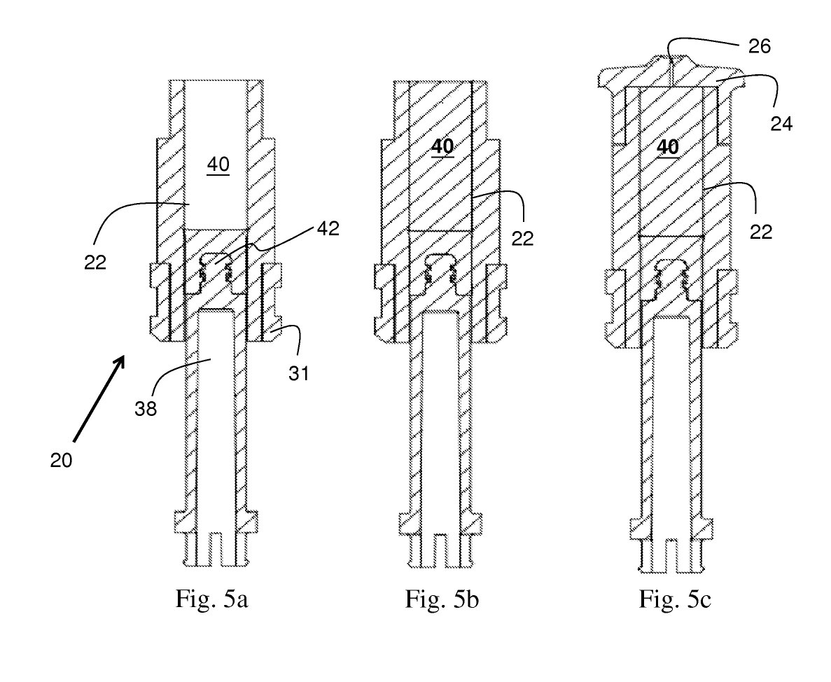

Upon assembling, the nozzle 20 needs to be loaded with a predetermined dosage of an injectable desired to be injected into the subject before usage. In an embodiment of the present invention as shown in FIG. 5a, the piston 38 is inserted into the space of the container member 22 at a position such that the nozzle ram 42 is located at a pre-determined position relative to the container member 22. As such, a fluid cavity 40 is defined in which the container member 22 and the nozzle ram 42 acts as the side wall and the rear wall of the fluid cavity 40 respectively. The predetermined position of the nozzle ram 42 is determined such that the volume of the fluid cavity 40 is exactly equal to the predetermined dosage. In one embodiment, the inner diameter of the container member 22 is the same as that of the diameter of the piston 38. In another embodiment, the inner diameter of the container member 22 is larger than that of the injection orifice 26. In the embodiment as shown in FIGS. 5a and 5b, the nozzle head 24 is not yet attached to the container member 22 of the assembled nozzle 20 at this stage.

The injectable is then filled into the defined fluid cavity 40 through the upward-facing open front end of the container member 22 under ambient pressure as illustrated in FIG. 5b. Once the filling is completed, the nozzle head 24 can be attached onto the front end of the container member 22 to act as the front wall of the fluid cavity 40. As such, the container member 22 is closed and the injectable is enclosed inside the fluid cavity 40 as shown in FIG. 5c. Any leakage of the injectable is thus prevented under ambient pressure. Once the nozzle head 24 is attached to the container member, the filled nozzle 20 is now ready to be used by a user with a needle-free injector for injection. In another embodiment, a nozzle cover (not shown) is attached onto the injection orifice 26 of the nozzle head 24 to protect the nozzle head 24 from contamination.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, the front flange 30 and the rear flange 31 are shown to be annular in FIG. 1. However, other shapes for each or both flanges may be used, such as oval, square, rectangular, triangular, cruciform, and polygonal in shape. In an exemplary embodiment, the shape thereof is designed to be specific to the type of injectable to be contained within the container member 22 according to one's needs for ease of identification. In one embodiment, the flange(s) can be shape-oriented for unique connection with the needle-free injector; as such, a needle-free injector adapted to use the nozzle is also designed to be only able to receive the nozzle having each or both flanges in the specific shape, ensuring that the both the injector and the nozzle are specific to the type of injectable to be injected.

Further, the length of the container member 22 can be varied and designed to be specific to the type of injectable to be contained within the container member 22 according to one's needs. In general, the longer the container member 22 is, the more the number of injection orifices 26 is present at the nozzle head 24.

Each injection base 36 as described above comprises only one injection orifice 26, but each injection base can also accommodate more than one injection orifice 26 according to the needs of the user.

In the embodiment as shown in FIG. 1, the container member 22 and the injector connector 28 are separate parts, but it is clear to one skilled in the art that the injector connector 28 can be incorporated into the container member 22 as a single piece. Likewise, the nozzle head 24 as shown is a separate piece from the container member 22, but it can also be assembled into the container member 22 as a one-piece device.

Further, the nozzle can also be made dedicated for the coupling of the piston with the corresponding injector connector and container member containing the injectable.

In addition to the filing method as afore-described and illustrated in FIGS. 5a-5c, it is clear to one skilled in the art that the nozzle can be filled with the injectables through the orifice using the conventional filing method.

What is claimed is:

1. A nozzle comprising:
a) a container member comprising an internal space and a first end with an attachment mechanism adapted to attach to a needle free injector; and
b) a nozzle head comprising a first end and a second end, said first end comprising an attachment part adapted to attach to said attachment mechanism of said container member, and said second end comprising a wall with at least one injection orifice;
wherein said container member and said nozzle head are separate parts but connectable to each other.

2. The nozzle according to claim 1, wherein said container member is adapted to contain an injectable within said internal space thereof; said attachment mechanism comprises an injector connector being hollow axially and adapted to attach to said first end of said container member; said injector connector and container member are separate parts but connectable to each other.

3. The nozzle according to claim 2, wherein said injector connector comprises a flange provided on a front end and a rear end thereof with a recess disposed between said flanges.

4. The nozzle according to claim 3, wherein the shape of at least one of said flanges of said injector connector is specific to the type of injectable contained within said container member.

5. The nozzle according to claim 3, wherein the rear end of said rear flange is frusto-conical in shape.

6. The nozzle according to claim 1, wherein the length of said container member is specific to the type of injectable contained therewithin.

7. The nozzle according to claim 1, wherein said nozzle head comprises a front surface with an enlarged area relative to said container member and protrudes convexly for interaction with the concave profile of sunken skin of a subject such that when pressure is applied during injection, the area of contact between the injector and the skin of the subject is increased.

8. The nozzle according to claim 1, further comprising a piston adapted to fittingly insert into said internal space of said container member; wherein said piston comprises a nozzle ram attached to a front end thereof, thereby defining a fluid cavity with said nozzle head acting as a front wall thereof, said container member acting as a side wall thereof, and said nozzle ram acting as a rear wall thereof.

9. A nozzle for a needle-free injector comprising a container member and a nozzle head;
said nozzle head comprising a front surface having at least one injection orifice through which injectable may be dispensed under pressure; wherein said front surface protrudes convexly for interaction with the concave profile of sunken skin of a subject such that when pressure is applied during injection, the area of contact between the injector and the skin of the subject is increased; whereby the pressure exerted onto the skin of the subject is reduced and the discomfort to the subject during injection is reduced.

10. The nozzle according to claim 9, wherein the number of said injection orifice is specific to the type of injectable and/or dosage of the injectable to be injected to a subject in need thereof.

11. The nozzle according to claim 9, wherein said nozzle head further comprises a wall;
said wall and said injection orifice are organized in an concentric fashion.

12. The nozzle according to claim 9 wherein said front surface of said nozzle head comprises an enlarged area relative to said container member.

13. A method of loading an injectable into a nozzle for a needle-free injector comprising the steps of:
a) providing a space in said nozzle;
b) filling said space with said injectable under ambient pressure within said space; and
c) closing said space to prevent leakage of said injectable under ambient pressure.

14. The method according to claim 13 wherein said step (a) further comprises providing a container member of said nozzle comprising a front end, a rear end, and said space disposed between said front and rear ends; and closing said rear end of said space by inserting fittingly a piston into said space at said rear end of said container member such that a nozzle ram disposed at a front end of said piston is located at a predetermined position relative to said container member.

15. The method according to claim 14, wherein said piston is stationary and remains at said predetermined position during the loading of said injectable into said internal space.

16. The method according to claim 13, wherein said step (b) further comprises loading a injectable into said space at a front end thereof; and attaching a nozzle head onto said front end, thereby enclosing said injectable in said nozzle.
